(19) United States
(12) Patent Application Publication
(10) Pub. No.: US 2019/0160637 A1
(43) Pub. Date: May 30, 2019

(54) HOSE CLAMP TOOL GUN

(71) Applicant: Jaw Ling Co., Ltd., Taichung City (TW)

(72) Inventor: Chih-Ying Tsai, Taichung City (TW)

(73) Assignee: Jaw Ling Co., Ltd., Taichung City (TW)

(21) Appl. No.: 15/825,419

(22) Filed: Nov. 29, 2017

(51) Int. Cl. B25B 25/00; B23Q 9/00

(52) U.S. Cl. CPC B25B 25/005; F16L 33/06; B23Q 9/0078

(57) ABSTRACT

A hose clamp tool gun contains: a body, a push rod, and a fixing rod. The body includes a power connector, a drive segment, and a switch. The switch is configured to start a power source to flow into an action cylinder of the drive segment. The push rod includes a sliding segment and a pushing segment opposite to the sliding segment, and the sliding segment slides in the action cylinder. The fixing rod is partially mounted in the drive segment and includes a slide groove and at least one retaining recess. The slide groove is configured to accommodate the pushing segment of the push rod, and the retaining recess is configured to retain a first clamp end of a hose clamp, wherein when the pushing segment of the push rod pushes a second clamp end of the hose clamp, the hose clamp is expanded.

### TECHNICAL FIELD

The present disclosure relates to a hose clamp tool, and more particularly to a hose clamp tool gun capable of expanding hose clamps of different sizes.

### BACKGROUND

A conventional hose clamp is employed to attach and seal a hose onto a fitting. The hose clamp is typically made of a flexible metal sheet and is formed in a ring shape, wherein two clamp ends are bent and extend out of a ring-shaped body of the hose clamp. By squeezing the two clamp ends of the hose clamp together with long nose pliers or a vise grip, a user can expand the hose clamp for fitting onto a hose. When the two clamp ends are released, the hose clamp attaches the hose onto the fitting.

The hose clamp is applicable for high-pressure fitting of vehicle or other machine hoses, so it often requires a large force to expand the hose clamp. However, the user holds the fitting with one hand and operates the long nose pliers or the vise grip with the other hand, thus having inconvenient operation. In addition, the fitting may be oily, such that gripping the long nose pliers or the vise grip securely by the user is difficult and increasing a risk that the hose clamp will slip easily from the long nose pliers or the vise grip causing operational danger.

### SUMMARY

A primary aspect of the present invention is to provide a hose clamp tool gun which assists a user to expand hose clamps of different sizes easily.

Another aspect of the present invention is to provide a hose clamp tool gun which assists a user to expand hose clamps of different sizes safely.

To obtain the above aspects, a hose clamp tool gun provided by the present invention contains: a body, a push rod, and a fixing rod.

The body includes a power connector, a drive segment, and a switch. The switch is configured to start a power source to flow into an action cylinder of the drive segment of the body.

The push rod includes a sliding segment arranged on a first end of the push rod, and the push rod includes a pushing segment formed on a second end of the push rod, wherein the sliding segment slides in the action cylinder in a reciprocating manner.

The fixing rod is partially mounted in the drive segment of the body, the fixing rod includes a slide groove and at least one retaining recess, wherein the slide groove is configured to accommodate the pushing segment of the push rod, and the at least one retaining recess is configured to retain a first clamp end of a hose clamp, wherein when the pushing segment of the push rod pushes a second clamp end of the hose clamp, the hose clamp is expanded.

Preferably, the power connector is coupled with a high-pressure air tube, and the switch is configured to turn on/off an air valve so as to control high-pressure air to flow or to stop flowing into the action cylinder of the drive segment.

Preferably, the action cylinder has a spring fitted on the push rod so as to push to the push rod to move back to an original position.

Preferably, the sliding segment has an O-ring formed on an inner wall thereof so as to enhance air tightness of action cylinder.

Preferably, the fixing rod further includes an affix ring secured in the drive segment of the body by using a screw nut.

Preferably, the drive segment has inner threads configured to screw with outer threads of the screw nut.

Preferably, the pushing segment has a notch defined thereon.

Preferably, the fixing rod further includes a stop block arranged on a top thereof opposite to the affix ring.

Preferably, the fixing rod includes at least two retaining recesses which are located at two different angles relative to the fixing rod respectively.

In another embodiment, a hose clamp tool gun contains: a push rod and a fixing rod.

The push rod includes a sliding segment arranged on a first end of the push rod, and the push rod includes a pushing segment formed on a second end of the push rod, wherein the sliding segment is manually pushed by user so as to urge the pushing segment to move.

The fixing rod includes a slide groove and at least one retaining recess, wherein the slide groove is configured to accommodate the pushing segment of the push rod, and the at least one retaining recess is configured to retain a first clamp end of a hose clamp, wherein when the pushing segment of the push rod pushes a second clamp end of the hose clamp, the hose clamp is expanded.

Other objects and features will be in part apparent and in part pointed out hereinafter.

### BRIEF DESCRIPTION OF THE DRAWINGS

FIG. 1 is a perspective view showing exploded components of a hose clamp tool gun according to a preferred embodiment of the present invention.

FIG. 2 is a perspective view showing the assembly of the hose clamp tool gun according to the preferred embodiment of the present invention.

FIG. 3 is a cross sectional view showing the assembly of a part of the hose clamp tool gun according to the preferred embodiment of the present invention.

FIG. 4 is a cross sectional view showing the operation of a part of the hose clamp tool gun according to the preferred embodiment of the present invention.

FIG. 5 is another cross sectional view showing the assembly of a part of the hose clamp tool gun according to the preferred embodiment of the present invention.

FIG. 6 is another cross sectional view showing the operation of a part of the hose clamp tool gun according to the preferred embodiment of the present invention.

Corresponding reference characters indicate corresponding parts throughout the drawings.

### DETAILED DESCRIPTION

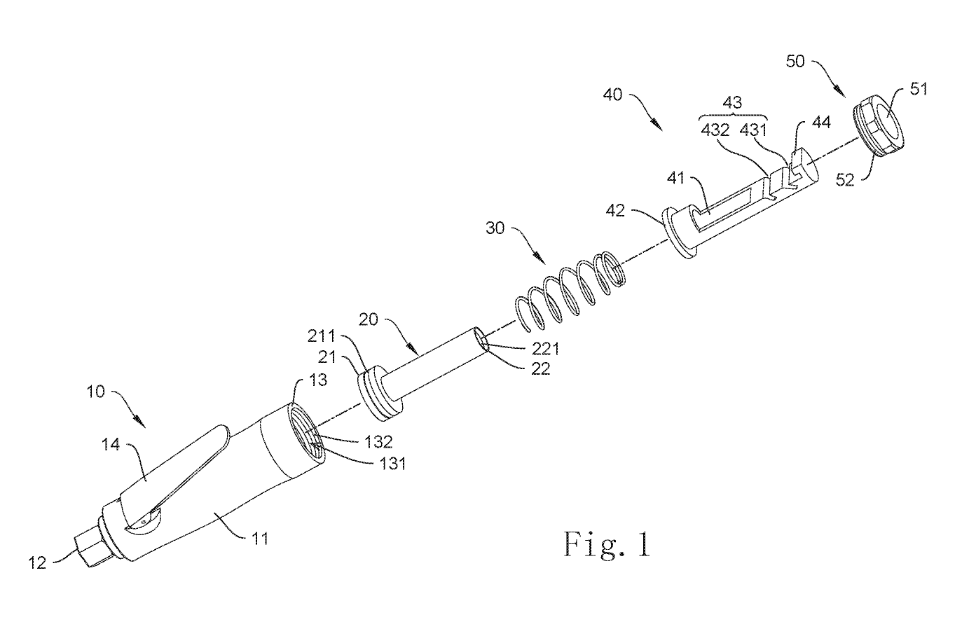

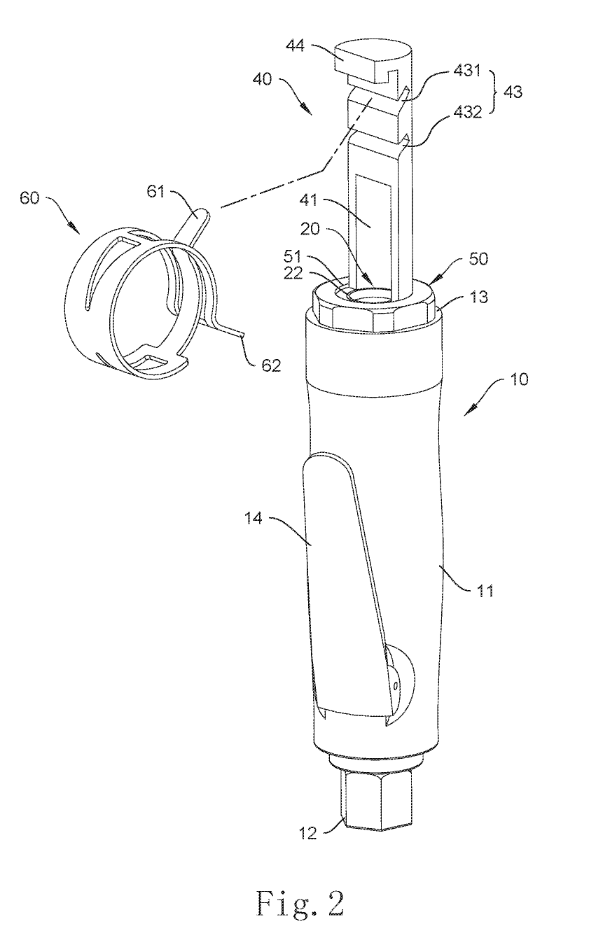

With reference to FIGS. 1 and 2, a hose clamp tool gun according to a preferred embodiment of the present invention comprises: a body 10 including a power connector 12, a drive segment 13, and a switch 14, wherein the drive segment 13 is connected with a power source, the switch 14 is configured to start the power source to flow into an action cylinder 131 of the drive segment 13 of the body 10; a push rod 20 including a sliding segment 21 arranged on a first end of the push rod 20, and the push rod 20 including a pushing segment 22 formed on a second end of the push rod 20, wherein the sliding segment 21 slides in the action cylinder 131 in a reciprocating manner; and a fixing rod 40 partially mounted in the drive segment 13 of the body 10, the fixing rod 40 including a slide groove 41 and at least one retaining recess 43, wherein the slide groove 41 is configured to accommodate the pushing segment 22 of the push rod 20, and the at least one retaining recess 43 is configured to retain a first clamp end of a hose clamp, wherein when the pushing segment 22 of the push rod 20 pushes a second clamp end of the hose clamp, the hose clamp is expanded.

The power connector 12 is coupled with a high-pressure air tube, an electric hammer or a screw rod of a push apparatus, and the high-pressure air tube, the electric hammer and the screw rod are the power source configured to drive the push rod 20 to move.

When the hose clamp tool gun is manually operated, the body of the hose clamp tool gun is eliminated. For example, the hose clamp tool gun comprises: a push rod 20 including a sliding segment 21 arranged on a first end of the push rod 20, and the push rod 20 including a pushing segment 22 formed on a second end of the push rod 20, wherein the sliding segment 21 is manually pushed by user so as to urge the pushing segment 22 to move; and a fixing rod 40 including a slide groove 41 and at least one retaining recess 43, wherein the slide groove 41 is configured to accommodate the pushing segment 22 of the push rod 20, and the at least one retaining recess 43 is configured to retain a first clamp end of a hose clamp, wherein when the pushing segment 22 of the push rod 20 pushes a second end of the hose clamp, the hose clamp is expanded.

When the power connector 12 is coupled with the high-pressure air tube in another embodiment, the hose clamp tool gun comprises: a body 10, a push rod 20, a spring 30, and a fixing rod 40. The body 10 includes a power connector 12, a drive segment 13, and a switch 14, wherein the body 10 further includes a grip portion 11 configured to be held by user, and the switch 14 is mounted on the grip portion 11; the power connector 12 is coupled with the high-pressure air tube which is connected with an air compressor, and the air compressor has high-pressure air stored therein, hence the high-pressure air tube is coupled with the power connector 12. The power connector 12 is a threaded connector or a quick connector. The switch 14 is configured to turn on/off an air valve (not shown) so as to control the high-pressure air to flow or to stop flowing into an action cylinder 131 of the drive segment 13. Since the power connector 12, the switch 14, and the air valve (not shown) are a well-known pneumatic tool, further remarks are omitted.

The hose clamp tool gun is a pneumatic tool, such as a gun/nailer or a caulk gun.

The push rod 20 includes a sliding segment 21 arranged on a first end thereof, and the push rod 20 includes a pushing segment 22 formed on a second end thereof, wherein the sliding segment 21 slides in the action cylinder 131 in a reciprocating manner. A diameter of the sliding segment 21 is less than that of the action cylinder 131 so that the push rod 20 slides smoothly in the action cylinder 131. Preferably, the sliding segment 21 has an O-ring 211 formed on an inner wall thereof so as to enhance air tightness of the push rod 20 and the action cylinder 131, hence when the high-pressure air flows into the action cylinder 131 from the power connector 12, the push rod 20 is pushed to move toward the action cylinder 131 of the body 10. Preferably, the pushing segment 22 has a notch 221 defined thereon.

The spring 33 is fitted on the push rod 20 so as to provide returning elasticity to the push rod 20, hence when the switch 14 is released to turn off the air valve (not shown), the high-pressure air is stopped flowing into the action cylinder 131 by the air valve. Thereafter, remaining air in the action cylinder 131 discharges out of an air outlet (not shown), and the spring 30 pushes the push rod 20 to move back to an original position.

The fixing rod 40 includes a slide groove 41 and at least one retaining recess 43, wherein the slide groove 41 is configured to accommodate the pushing segment 22 of the push rod 20, and the at least one retaining recess 43 is configured to retain a first clamp end 61 of a hose clamp 60, wherein when the pushing segment 22 of the push rod 20 pushes a second clamp end 62 of the hose clamp 60, the hose clamp 60 is expanded.

Preferably, the fixing rod 40 further includes an affix ring 42 secured in the drive segment 13 of the body 10 by using a screw nut 50, and the drive segment 13 has inner threads 132 configured to screw with outer threads 52 of the screw nut 50, such that the fixing rod 40 is replaceable so as to mate with hose clamps of different sizes. The screw nut 50 includes a through orifice 51 configured to insert the fixing rod 40.

Preferably, the fixing rod 40 includes at least two retaining recesses 43, i.e., a first retaining recess 431 and a second retaining recess 432 which are formed on two different oppositions of the fixing rod 40 respectively. Preferably, the first retaining recess 431 and the second retaining recess 432 are located on different angles relative to the fixing rod 40 respectively, for example, the first retaining recess 431 is located at 45 degrees relative to the fixing rod 40, and the second retaining recess 432 is located at 60 degrees relative to the fixing rod 40, hence the fixing rod 40 mates with various clamped angles of the hose clamps of different brands or sizes.

Preferably, the fixing rod 40 further includes a stop block 44 arranged on a top thereof opposite to the affix ring 42, wherein the stop block 44 extends over an opening of the two retaining recesses 43 so that when the first clamp end of the hose clamp removes from one of the two retaining recesses 43, the stop block 44 fixes the hose clamp 44.

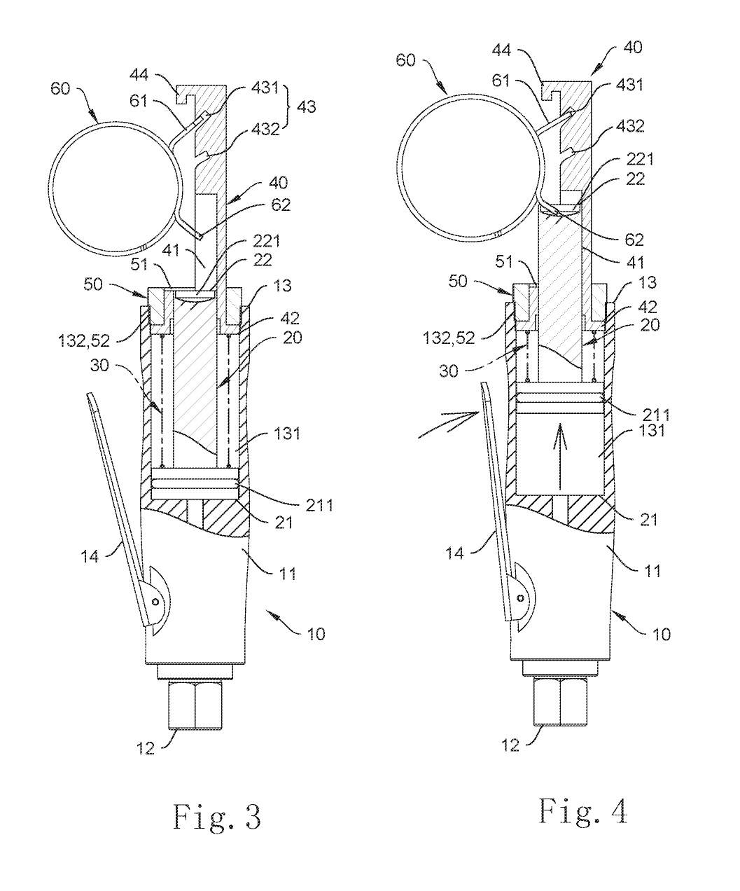

Referring to FIG. 3, when the hose clamp 60 has a larger diameter, the first clamp end 61 is retained in the first retaining recess 431, the second clamp end 62 is accommodated in the slide groove 41, and the hose clamp 60 is manually held by one hand or is clamped by long-nose pliers.

As shown in FIG. 4, the grip portion 11 is held by the other hand and the switch 14 is pressed so as to guide the high-pressure air to flow into the action cylinder 131, and the high-pressure air pushes the push rod 20 to move out of the drive segment 13 so that the pushing segment 22 pushes the second clamp end 62 to move to the first clamp end 61 in the first retaining recess 431, hence the hose clamp 60 is expanded as pressing the switch 14. Thereafter, the hose clamp 60 is moved to a hose and the switch 14 is released so that the spring 30 pushes the push rod 20 to the original position, and the second clamp end 62 is released so that the hose clamp 60 clamps the hose.

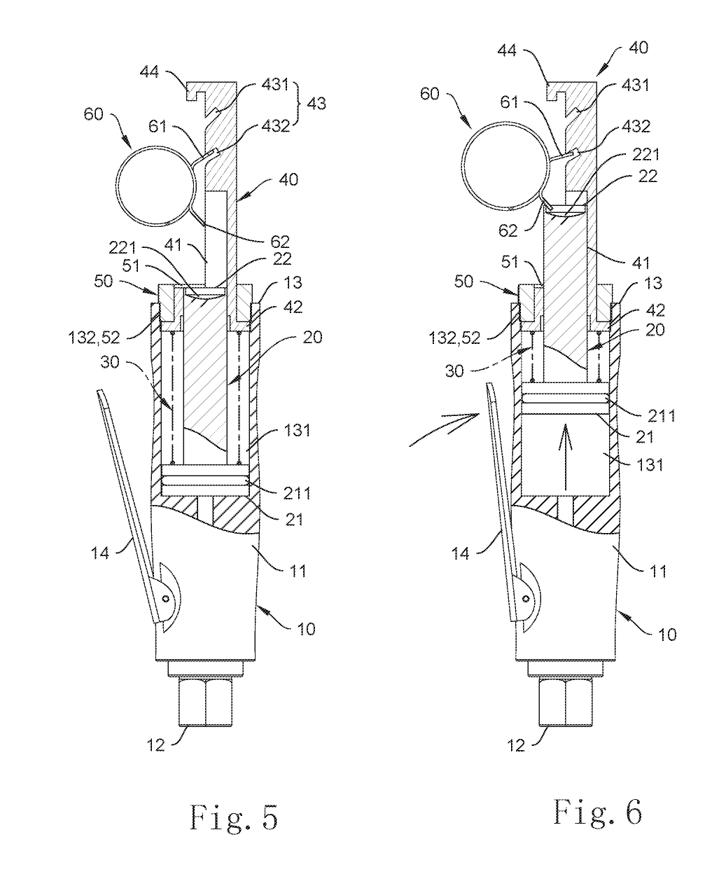

With reference to FIG. 5, when the hose clamp 60 has a small diameter, the first clamp end 61 is retained in the second retaining recess 432, the second clamp end 62 is accommodated in the slide groove 41, and the hose clamp 60 is manually held by one hand or is clamped by the long-nose pliers.

As illustrated in FIG. 6, the grip portion 11 is held by the other hand and the switch 14 is pressed so as to guide the high-pressure air to flow into the action cylinder 131, and the high-pressure air pushes the push rod 20 to move out of the drive segment 13 so that the pushing segment 22 pushes the second clamp end 62 to move to the first clamp end 61 in the second retaining recess 432, hence the hose clamp 60 is expanded as pressing the switch 14. Thereafter, the hose clamp 60 is moved to the hose and the switch 14 is released so that the spring 30 pushes the push rod 20 to the original position, and the second clamp end 62 is released so that the hose clamp 60 clamps the hose.

The notch 221 is configured to house the second clamp end 62 so as to avoid a removal of the second clamp end 63 from the pushing segment 22.

When a size of the hose clamp 60 is more than a set operation range, the screw nut 50 is unscrewed so as to remove the fixing rod 40, and another fixing rod 40 replaces the fixing rod 40 so as to mate with another hose clamp 60 of a larger size.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

Having described the invention in detail, it will be apparent that modifications and variations are possible without departing from the scope of the invention defined in the appended claims.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A hose clamp tool gun comprising:
a body including a power connector, a drive segment, and a switch, the switch being configured to start a power source to flow into an action cylinder of the drive segment of the body;
a push rod including a sliding segment arranged on a first end of the push rod, and the push rod including a pushing segment formed on a second end of the push rod, the sliding segment sliding in the action cylinder; and
a fixing rod partially mounted in the drive segment of the body, the fixing rod including a slide groove and at least one retaining recess, wherein the slide groove is configured to accommodate the pushing segment of the push rod, and the at least one retaining recess is configured to retain a first clamp end of a hose clamp, wherein when the pushing segment of the push rod pushes a second clamp end of the hose clamp, the hose clamp is expanded.

2. The hose clamp tool gun as claimed in claim 1, wherein the power connector is coupled with a high-pressure air tube, and the switch is configured to turn on/off an air valve so as to control high-pressure air to flow or to stop flowing into the action cylinder of the drive segment.

3. The hose clamp tool gun as claimed in claim 2, wherein the fixing rod includes at least two retaining recesses which are located at two different angles relative to the fixing rod respectively.

4. The hose clamp tool gun as claimed in claim 2, wherein the action cylinder has a spring fitted on the push rod so as to push to the push rod to move back to an original position.

5. The hose clamp tool gun as claimed in claim 4, wherein the fixing rod includes at least two retaining recesses which are located at two different angles relative to the fixing rod respectively.

6. The hose clamp tool gun as claimed in claim 4, wherein the sliding segment has an O-ring formed on an inner wall thereof so as to enhance air tightness of action cylinder.

7. The hose clamp tool gun as claimed in claim 6, wherein the fixing rod includes at least two retaining recesses which are located at two different angles relative to the fixing rod respectively.

8. The hose clamp tool gun as claimed in claim 6, wherein the fixing rod further includes an affix ring secured in the drive segment of the body by using a screw nut.

9. The hose clamp tool gun as claimed in claim 8, wherein the fixing rod includes at least two retaining recesses which are located at two different angles relative to the fixing rod respectively.

10. The hose clamp tool gun as claimed in claim 8, wherein the drive segment has inner threads configured to screw with outer threads of the screw nut.

11. The hose clamp tool gun as claimed in claim 10, wherein the fixing rod includes at least two retaining recesses which are located at two different angles relative to the fixing rod respectively.

12. The hose clamp tool gun as claimed in claim 1, wherein the fixing rod further includes a stop block arranged on a top thereof opposite to the affix ring.

13. The hose clamp tool gun as claimed in claim 12, wherein the fixing rod includes at least two retaining recesses which are located at two different angles relative to the fixing rod respectively.

14. The hose clamp tool gun as claimed in claim 1, wherein the fixing rod includes at least two retaining recesses which are located at two different angles relative to the fixing rod respectively.

15. A hose clamp tool gun comprising:
a push rod including a sliding segment arranged on a first end of the push rod, and the push rod including a pushing segment formed on a second end of the push rod, the sliding segment being manually pushed by user so as to urge the pushing segment to move; and
a fixing rod including a slide groove and at least one retaining recess, wherein the slide groove is configured to accommodate the pushing segment of the push rod, and the at least one retaining recess is configured to retain a first clamp end of a hose clamp, wherein when the pushing segment of the push rod pushes a second clamp end of the hose clamp, the hose clamp is expanded.
